(19) United States
(12) Patent Application Publication
(10) Pub. No.: US 2011/0062644 A1
(43) Pub. Date: Mar. 17, 2011

(54) CONVEYOR BELT CLAMP

(76) Inventors: Adam Zehnder, Emmaus, PA (US); Aaron Gibbs, Easton, PA (US); Thomas Krulick, Allentown, PA (US)

(21) Appl. No.: 12/643,370

(22) Filed: Dec. 21, 2009

Related U.S. Application Data
(60) Provisional application No. 61/242,110, filed on Sep. 14, 2009.

(51) Int. Cl. B25B 1/24; B23Q 7/00

(52) U.S. Cl. 269/257; 29/559

(57) ABSTRACT

A conveyor belt clamp and method may comprise: first and second clamp beams for being placed against a conveyor belt, one or both of the clamp beams may be pre-stressed for deflecting a central region along its length. First and second end clamps are placed over the ends of the clamp beams, and each of the end clamps includes a tightening device for forcing the ends of the clamp beams closer together. The pre-stressed clamp beam is placed with its convex side against the conveyor belt. A conveyor belt clamp may comprise: first and second clamp beams for being placed against a conveyor belt, one or both of the clamp beams may include a center clamp for applying clamping force to the conveyor belt.

This application claims the benefit of the filing date of U.S. Provisional Patent Application No. 61/242,110 entitled “CONVEYOR BELT CLAMP” filed Sep. 14, 2009, which is hereby incorporated herein by reference in its entirety.

The present invention relates to a belt clamp and, in particular, to a conveyor belt clamp.

Conveyor belt clamps are widely used to attach a pulling device to the end of a conveyor belt for the purpose of moving the end of the conveyor belt to another location by pulling longitudinally, i.e. in the direction the belt normally travels when used as a conveyor. For example, a belt may be pulled to install the belt onto a conveyor system or to remove the belt from the conveyor system. Typically, conventional belt clamps only effectively pull the edges of the belt, which can cause damage to the belt and/or generate uneven pulling forces across the width of the belt.

In a conveyor, it is often necessary to pull the ends of a conveyor belt towards one another so that the ends can be joined or spliced. To have a good joining, e.g., a splice, the two ends to be joined should be straight and aligned, whether the ends are cut transverse to the direction of belt travel at a right angle or at another angle, so that the ends meet along their entire lengths where the joint is to be made. If the belt is pulled more at its edges, then the end of the belt will tend to become concave as it is pulled and the edges of the end of the belt will meet before the centers of the ends of the belt meet, thereby making a uniform and strong joint (splice) more difficult to achieve.

In the present state of the art, mechanical belt clamps consist of two basic types. One type employs two simple beams, one adjacent to each surface of a conveyor belt, that span the width of the belt with the belt between them. Clamping mechanisms exterior to each edge of the belt are employed to force the respective ends of the two beams together outboard of or near the edges of the belt. As the ends of the beams are forced together to clamp the belt between the beams, the edges of the belt tend to act as pivot points, thereby causing one or both of the beams to deflect (bend) slightly and/or the edge of the belt to compress slightly. As a result, the conventional clamped beams exert greater force on the edges of the belt than at the center of the belt. Thus, when the belt is pulled by pulling on the conventional belt clamp, the edges of the belt tend to be pulled to a greater extent than does the center of the belt, resulting in uneven forces pulling the belt across its width.

When the belt being clamped is of sufficient width, e.g., 48″ (about 1.2 m.) and wider, the forces across the width of the belt are not consistent (not uniform) and can vary to the point where it is difficult to pull the ends of the belt together accurately. Many belts are more than 96″ (about 2.4 m.) wide, which makes it even more difficult to obtain even pulling forces to accurately pull together and join the ends of the belt.

The second type of conventional belt clamp has two separate clamps that are independently clamped to the opposing edges of the conveyor belt. These clamps exert all of the pulling force at the edge of the belt and none in the center, and so necessarily experience the uneven pulling force problem as described.

Thus there is a need for a conveyor belt clamp that can reduce the non-uniformity of force across the width of the belt.

To this end, a conveyor belt clamp may comprise: first and second clamp beams for being placed against a conveyor belt, one or both of the clamp beams may be pre-stressed for deflecting a central region along the length of the clamp beam; first and second end clamps are for being placed over the ends of the clamp beams, and each of the end clamps includes a tightening device for forcing the ends of the clamp beams closer together. The pre-stressed clamp beam is placed with its convex side against a conveyor belt.

In another aspect, a method for clamping a conveyor belt may comprise:
providing first and second clamp beams, one or both of which is pre-stressed for having a convex side;
placing the first and second clamp beams transversely across a conveyor belt with the conveyor belt therebetween and with the convex side of the one or both clamp beams adjacent the conveyor belt;
placing a first end clamp over first ends of the first and second clamp beams;
placing a second end clamp over second ends of the first and second clamp beams; and
tightening the first and second end clamps for forcing the ends of the first and second clamp beams closer together for clamping the conveyor belt therebetween.

According to another aspect, a conveyor belt clamp may comprise: first and second elongated clamp beams; at least one center clamp on at least one of the first and second elongated clamp beams at a location between the first and second ends thereof; first and second end clamps each comprising a frame and a tightening device, the frame of the end clamp for being placed over an end of each of the first and second elongated clamp beams, wherein the tightening device is tightenable for forcing the ends of the first and second elongated clamp beams closer together; and the at least one center clamp is tightenable for applying clamping force to the conveyor belt at the location between the first and second ends of the first and second elongated clamp beams.

### BRIEF DESCRIPTION OF THE DRAWING

The detailed description of the preferred embodiment(s) will be more easily and better understood when read in conjunction with the FIGURES of the Drawing which include:

FIG. 1 is an isometric view of an example embodiment of a conveyor belt clamp that is clamped to a cut end of a conveyor belt for pulling the cut end of the belt;

FIG. 2 is an isometric view of two of the example conveyor belt clamps of FIG. 1 that are clamped to opposing cut ends of a conveyor belt for pulling the cut ends of the belt together for splicing;

FIG. 3 includes FIGS. 3A through 3D wherein:

FIG. 3A is a side elevation view of the example conveyor belt clamp of FIG. 1 with pre-stressed upper and lower clamp bars in position prior to contact with the conveyor belt;

FIG. 3B is a side elevation view of the example conveyor belt clamp of FIG. 3 with pre-stressed upper and lower clamp bars in position of making initial contact with the conveyor belt and the two end clamps in position to exert clamping force on the ends of the upper and lower clamp bars;

FIG. 3C is a side elevation view of the example conveyor belt clamp of FIGS. 3-4 with the upper and lower clamp bars in the clamped condition in contact with the conveyor belt and with the two end clamps forcing the ends of the upper and lower clamp bars together;

FIG. 3D is a side elevation view of the example conveyor belt clamp of FIGS. 3-5 with the upper and lower clamp bars in the clamped condition in contact with the conveyor belt and the end clamps forcing the ends of the upper and lower clamp bars together, wherein the center clamp device is exerting force on the center of the conveyor belt to force the upper and lower clamp bars into reverse deflection;

FIG. 4 is an end view of an example end clamp of the conveyor belt clamp of FIG. 1 showing details of the end clamp;

FIG. 5 includes FIGS. 5A and 5B that are cross-ways and longitudinal sectional views, respectively, of a clamp beam that show an example arrangement of tensioning rods therein;

FIG. 6 is an isometric view of a prior art conveyor belt clamp clamped to a conveyor belt to illustrate the uneven distribution of pulling forces across the width of a conveyor belt obtained thereby;

FIG. 7 is an isometric view of an example conveyor belt clamp of FIG. 1 clamped to a conveyor belt to illustrate the relatively more even distribution of pulling forces across the width of the conveyor belt obtained thereby; and

FIG. 8 is an isometric view of an example embodiment of a conveyor belt clamp having plural intermediate clamping devices along its length and that is clamped to a cut end of a conveyor belt for pulling the cut end of the belt.

In the Drawing, where an element or feature is shown in more than one drawing figure, the same alphanumeric designation may be used to designate such element or feature in each figure, and where a closely related or modified element is shown in a figure, the same alphanumerical designation primed or designated “a” or “b” or the like may be used to designate the modified element or feature. It is noted that, according to common practice, the various features of the drawing are not to scale, and the dimensions of the various features are arbitrarily expanded or reduced for clarity, and any value stated in any Figure is given by way of example only.

### DESCRIPTION OF THE PREFERRED EMBODIMENT(S)

The conveyor belt clamp of the present arrangement pre-stresses the beams that are used for clamping the belt so that they exert forces in the center of the belt as well as at the edges of the belt, thereby to provide a more even and effective force distribution across the width of the belt than is provided by a conventional belt clamp

The conveyor belt clamp of the present arrangement tends to mitigate the disadvantages of the prior art belt clamps by utilizing one or more pre-tensioned (pre-stressed) beams that together will tend to exert a relatively more uniform force across the width of the belt when clamping forces are applied to the beams at the edges of the belt. One of the beams, usually the one positioned as the upper beam, may have an additional clamping device near the center of its length so as to create additional clamping force near the center of the belt, and/or may have plural additional clamping devices at intermediate locations across the width of the belt, as might be advantageous for longer beams intended for use with wider belts.

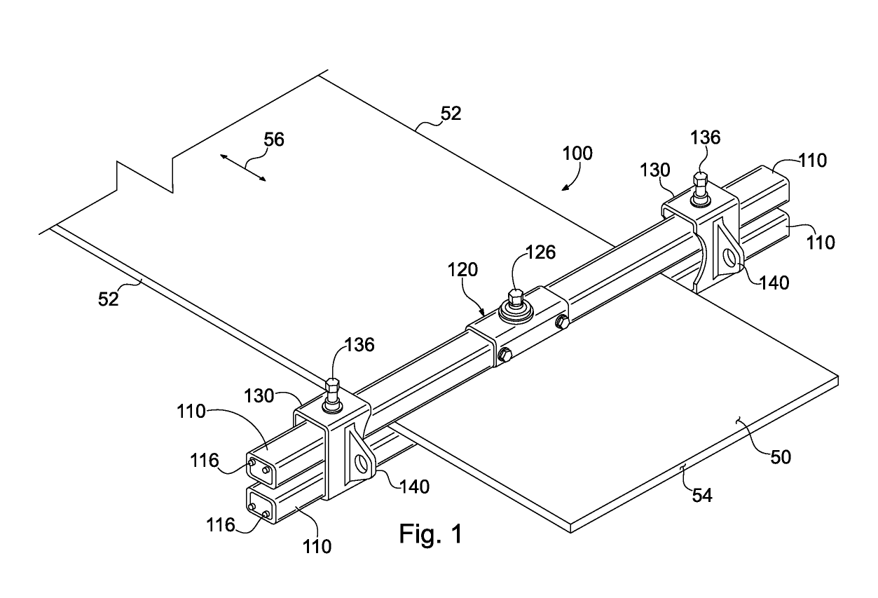

FIG. 1 is an isometric view of an example embodiment of a conveyor belt clamp 100 that is clamped to a cut end 54 of a conveyor belt 50 for pulling the cut end 54 of the belt 50. The first and second bars 110, 110′ of the conveyor belt clamp 100, also referred to as the upper and lower bars thereof, are generally identical except that one of the bars 110, typically the first bar or the bar placed in the upper bar position, typically has a clamping device or pusher 120 located generally near the center thereof. The central pusher device 120 allows clamping pressure to be applied near the center of the conveyor belt 50 in cooperation with the two end clamps 130 which are located near the opposite ends of the clamping bars, e.g., outboard of the edges 52 of the conveyor belt 50.

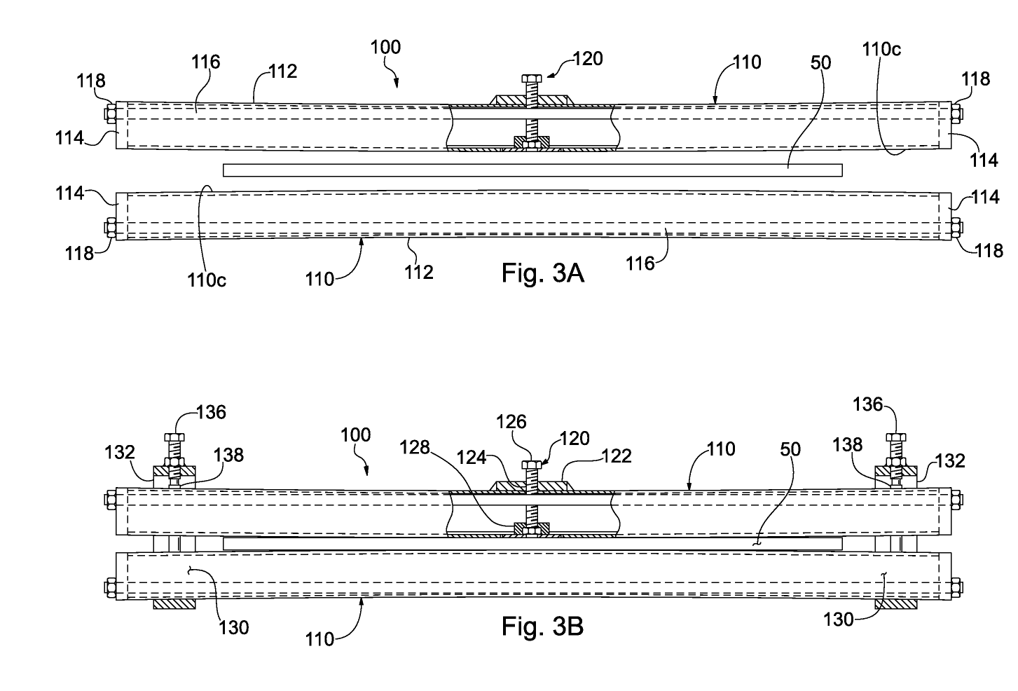

Placing of the first and second bars with the conveyor belt therebetween, and with the end clamps located at the ends of the first and second bars, is described in relation to FIGS. 3-6 below. It is noted that tightening the screws or bolts 136 of the end clamps 130 causes the conveyor belt 50 to be clamped between the upper an lower bars 110, 110′, generally with an even pressure on conveyor belt 50 due to the pre-stress on the first and second bars 110, 110′ which causes a slight bowing so that the center of the bars contact the conveyor belt first. Then the screw or bolt 126 of the clamping device located generally near to the center of the first and second bars 110, 110′, and generally near to the center of the conveyor belt 50, may be tightened to further improve the uniformity of the pressure with which the conveyor belt clamp grasps the conveyor belt. The clamping device 120 is preferably located on the upper bar, generally near to the center thereof.

Each end clamp has an eye or lug 140, 142 or other feature to which a cable or other means can be attached for pulling on the conveyor belt 50 by pulling on the conveyor belt clamp 100 according to the described arrangement. The conveyor belt clamp 100 is generally clamped to the conveyor belt 50 in the vicinity of an end 54 thereof, typically near a cut end 54 intended for being spliced.

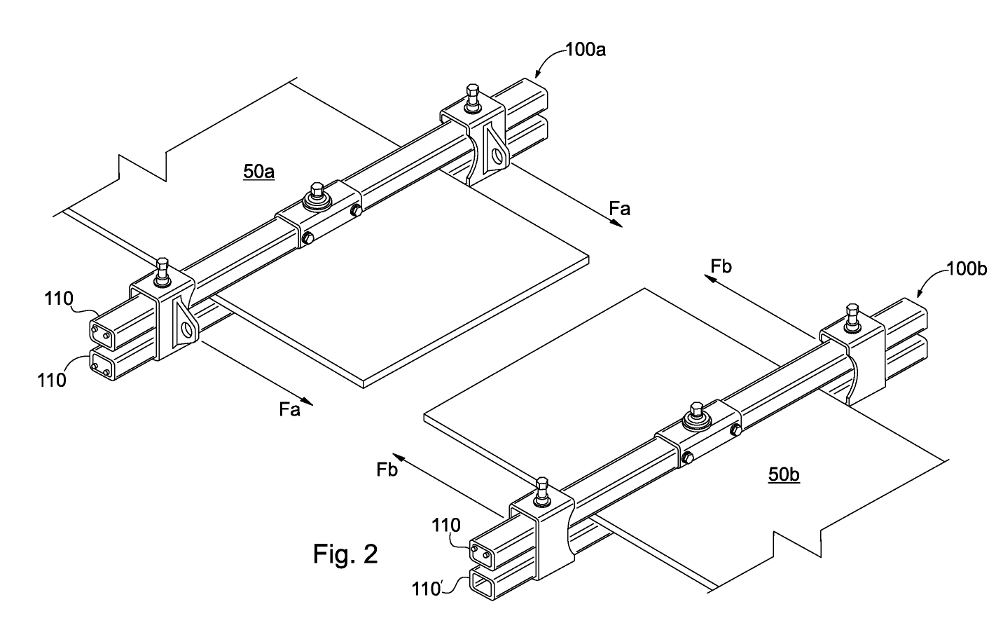

FIG. 2 is an isometric view of two of the example conveyor belt clamps 100a, 100b of FIG. 1 that are clamped to opposing cut ends of a conveyor belt for pulling the cut ends of the belt together for splicing, as indicated by the arrows Fa, Fb extending along the conveyor belt from the respective pulling eyes 140 of the two conveyor belt clamps.

In the illustrated arrangement, both beams 110 have one or more tension rods installed internally in the beam. The tension rods are installed using end plates at each end of each beam and at least one tension nut that can be tightened to pre-stress the tension rod for pre-stressing the beam. The tension rods are located off of the beam neutral axis, so that when the tension rods are tensioned the beam deflects or bends. As a result, the beams when placed with their convex sides adjacent the conveyor belt will have their respective ends slightly further away from the edges of the conveyor belt than is the center of the beams from the center of the conveyor belt.

When the ends of the beams are forced together by the tightening of the end clamps 130, the center of the pre-stressed beam or beams 110 will contact the center of the conveyor belt 50 first. Then as the ends of the beams are brought together as the end clamps 130 are tightened further, the clamping force against the belt from the upper and lower beams will become distributed evenly across the width of the belt, e.g., more evenly than with a conventional belt clamp. The optional center pusher clamp 120 may be used to apply additional force or pressure near the center of the conveyor belt 50 in order to get additional clamping pressure between the clamp bars 110, 110′ and the conveyor belt 50.

In general, the holding of the conveyor belt between the clamping bars is produced by the clamping force of the bars of the conveyor belt clamp against the conveyor belt and by the friction between the bars and the conveyor belt. A more even distribution of clamping force along the length of the clamping bars will, in general, produce a more even distribution of the pulling force across the width of the conveyor belt when the conveyor belt clamp is pulled, e.g., by the eyes thereof.

FIG. 3 includes FIGS. 3A through 3D illustrating a typical sequence of positioning and successively tightening the conveyor belt clamp on a conveyor belt. In practice, these usually are not stopping points, but are “snapshots” at various stages during the tightening process.

FIG. 3A is a side elevation view of the example conveyor belt clamp 100 of FIG. 1 with pre-stressed upper and lower clamp bars 110 in position prior to coming into contact with the conveyor belt 50. In this example, both the upper and lower bars 110 are pre-stressed by their respective tension bars 116, and so both are slightly curved so that the centers thereof are closer to the conveyor belt than are the ends thereof. The one tensioned bar positioned above the top of the belt preferably has an optional additional clamping device 120 near the center thereof which can be tightened so as to apply additional clamping force near the center of the conveyor belt. The other tensioned bar positioned below the conveyor belt typically does not include an additional clamping device.

While both the upper and lower bars 110 are illustrated as being pre-stressed or tensioned so as to have a slight curvature away from the conveyor belt at their ends, it is sufficient in many applications that only one of the two bars 110, 110′ be a pre-stressed or tensioned bar. Further, where the conveyor belt is relatively wide, one or more additional clamping devices 120 may be provided on one of the bars 110, 110′, generally but not necessarily, on the upper bar as a matter of convenience in being able to access the device for tightening it. The additional clamping devices typically include a screw or bolt or other mechanism 126 for increasing and decreasing the force they apply to the conveyor belt. Preferably, the optional additional clamping device or devices 120 is/are retracted when the upper bar or other bar including such optional clamping device is initially placed against the belt and as the bars are subsequently, at least initially, clamped together.

FIG. 3B is a side elevation view of the example conveyor belt clamp 100 of FIG. 3A with pre-stressed upper and lower clamp bars 110 in a condition of making initial contact with the conveyor belt 50 and the two end clamps 130 in position to exert clamping force on the ends of the upper and lower clamp bars 110. This condition obtains as the end clamps 130 are slipped over the ends of the two bars 110 and are initially tightened from the condition of FIG. 3A until the upper and lower bars come into contact with the conveyor belt. Rotating the bolt 136 of the end clamp 130 so that it advances into the end clamp causes the bearing plate 138 therein to move towards the beams to exert a force that presses the bars together against the frame 132 of the end clamp.

Because both the upper and lower bars are pre-stressed or tensioned in this example, each is slightly bowed and is placed so as to present a convex side 110c toward the conveyor belt. As a result, the centers of both the upper and lower beams tend to contact the conveyor belt first and to do so near the center of the belt, if the clamp bars 110 are placed as shown, which is not necessary. Where only one of the beams 110, 110′ is tensioned, then only that beam 110 would have a convex side 110c that is placed into contact with the conveyor belt.

Optional center clamp 120 includes a frame 122 that may be attached, e.g., by welding or bolts or other fasteners, to clamp beam 110 and a threaded hole 124 through which a bolt or other threaded member 126 may be threaded. Center clamp 120 applies clamping force to conveyor belt 50 when tightening device 126 is rotated in hole 124 to advance toward conveyor belt 50 thereby to press pressure plate 128 against belt 50, and clamping force is reduced or removed by rotating tightening device 126 in the opposite direction so that it withdraws away from conveyor belt 50.

FIG. 3C is a side elevation view of the example conveyor belt clamp 100 of FIGS. 3A-3B with the upper and lower clamp bars 110 in the clamped condition in contact with the conveyor belt 50 and with the two end clamps 130 tightened to force or draw the ends of the upper and lower clamp bars 110 together. The two end clamps 130 are both tightened against the pre-stress of the tensioned bars to draw the respective ends of the bars closer together, e.g., at least until the sides 110c adjacent the conveyor belt are substantially parallel as shown. The center clamp 120 is preferably not yet tightened.

FIG. 3D is a side elevation view of the example conveyor belt clamp 100 of FIGS. 3A-3C with the upper and lower clamp bars 110 in the fully clamped condition in contact with the conveyor belt 50 and the end clamps 130 forcing the ends of the upper and lower clamp bars together, wherein the ends of the clamp bars 110 are tightened sufficiently to apply a desired holding force at the edges 52 of the conveyor belt 50. The center clamp device 120 is tightened so as to exert force at the center of the conveyor belt to force the upper and lower clamp bars 110 into reverse deflection.

At this final stage of tightening of end clamps 130 and the center clamp 120, each has preferably been tightened to a predetermined degree so that the gripping of the conveyor belt 50 is relatively more uniform across the width of the conveyor belt. This can be controlled, e.g., by tightening the respective bolts 136, 126 of the end clamps 130 and of the center clamp 120 to a pre-determined torque, as might be done using a torque wrench or other torque applying device.

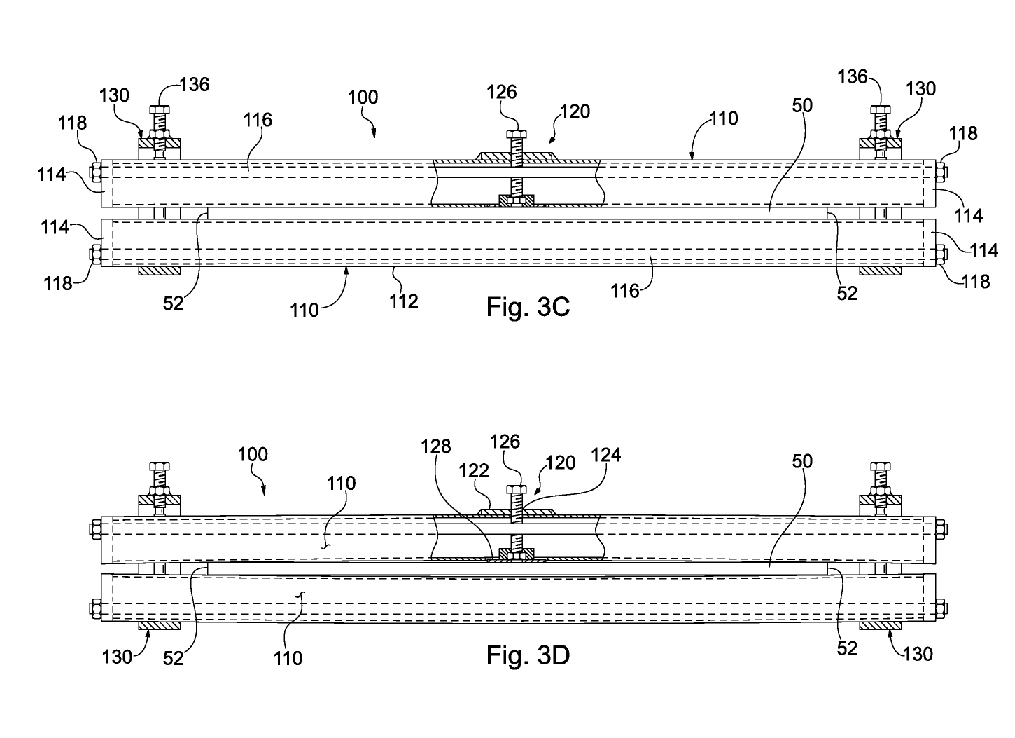

FIG. 4 is an end view of an example end clamp 130 of the conveyor belt clamp of FIG. 1 showing details of the end clamp 130. The end clamp 130 comprises a frame 132 suitable for placing a tightening device 136 against one of the clamp bars 110 and for holding the other of the clamp bars 110 so that force can be applied to both to draw them closer together. The clamp frame 132 may be rectangular as illustrated or may be another suitable shape, e.g., a “C” shape.

A threaded opening 134 at one end of the clamp frame 132 receives a clamp bolt 136 that can be rotated therein for advancing the clamp bolt 136 and the pressure plate 138 at its end to force the clamp bars 110 closer together, and for withdrawing the clamp bolt 136 for loosening and releasing the clamp bars 110, e.g., by applying a wrench to the head of the clamp bolt 136. The threaded opening 134 may be provided by a threaded hole through the clamp frame, or by a nut 134 attached thereto, e.g., by welding, or by a nut or other element 134 extending the length of the threaded opening provided by the threaded hole in the clamp frame and the nut.

The clamp frame 132 preferably includes a pulling eye or pulling lug 140 as a convenience for attaching a cable or other device, e.g., placed in the opening 142 of the pulling lug 140, for pulling on the clamp bar 100 and the conveyor belt 50 on which it is clamped. Absent a pulling lug 140, a cable loop could be placed over the tightened clamp bars for exerting pulling forces on the clamp bars and the conveyor belt.

FIG. 4 also illustrates a detail of the end of the clamp bars 110 which include an end plate 114 disposed at the respective ends of the clamp bars 110. The end plates 114 have one or more openings which are offset towards the same edge of the end plate 114 through which ends of the tensioning rods 116 extend for having a nut or other fastener 118 placed thereon that can be tightened to pre-tension the clamp bars 110. Tightening of the tensioning nuts 118 tends to place the tensioning rods 116 in tension which, because they are offset relative to the longitudinal center CL, NA of the clamp bars, tend to compress one of the long sides of the clamp bars relative to the opposing long side thereof, whereby the clamp bar will bend or distort in a pre-stressed or tensioned condition.

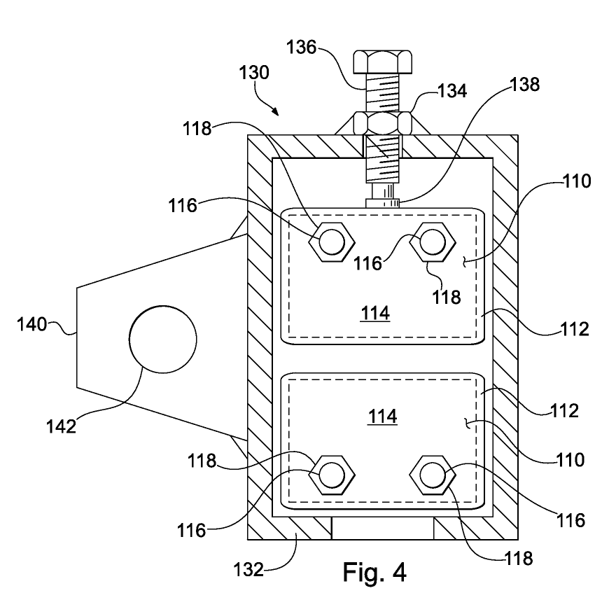

FIG. 5 includes FIGS. 5A and 5B that are cross-ways and longitudinal sectional views, respectively, of a clamp beam 110 that show the arrangement of tensioning rods 116 therein. While beams 110, 112 may have walls of the same thickness, it is preferred that one wall be thicker than the other three walls, and that the thicker wall 110c provide the convex side 110c that is to be placed adjacent to or against the conveyor belt 50. Because one wall is thicker than the other walls, the neutral axis NA of the beam 112 is offset from the centerline CL of the beam 112 towards the thicker wall 110c. The centerline CL is the physical center, e.g., the mid-point, between opposing outer surfaces of the beam, whereas the neutral axis NA is where longitudinal tensioning forces, if applied, would compress the beam 112 without bending the beam one way or the other. If the beam 112 is symmetrical, then the centerline CL and the neutral axis NA would coincide. The centerline CL and neutral axis NA are shown in one direction for explaining the bending of beam 110, 112 under tension, and the coincident centerline and neutral axis in the direction perpendicular to those shown in this example are not shown.

A tensioning force applied offset from the neutral axis NA in the direction away from the thicker wall 110c will cause beam 110, 112 to bend in a direction that bows the thicker wall 110c outward to produce a convex side 110c. Where two tensioning rods 116 are employed as illustrated, they are disposed symmetrically about the un-shown centerline so that beam 110, 112 bends in the desired direction and remains straight in the other direction. Preferably tensioning force is applied by alternatingly tightening the tensioning nuts 118 against end plates 114 so that the tensioning force applied by each tensioning rod 116 remain relatively even. If only one tensioning rod 116 were to be employed, it would be offset from the neutral axis NA and on the un-shown centerline in the perpendicular direction, i.e. symmetrical with respect to the opposing thinner walls of beam 112.

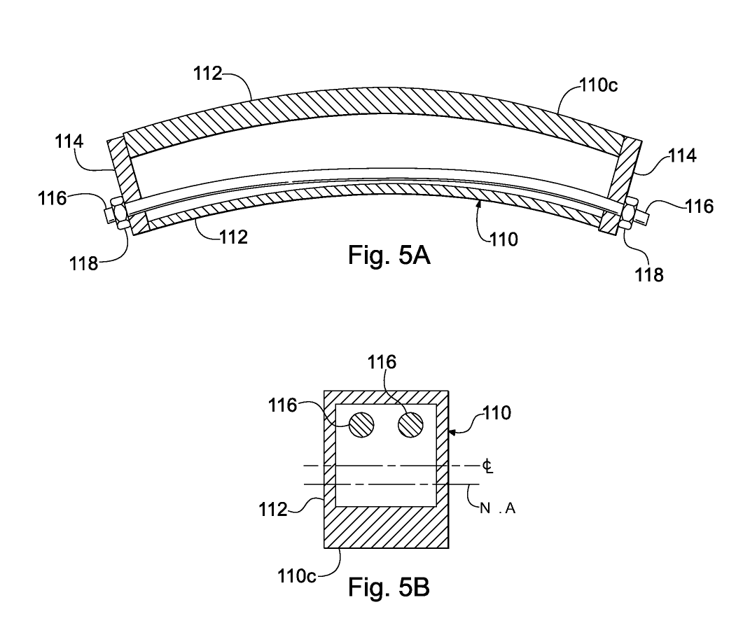

FIG. 6 is an isometric view of a prior art conveyor belt clamp clamped to a conveyor belt 50 to illustrate the uneven distribution of pulling forces across the width of a conveyor belt obtained thereby. The prior art clamp employs clamping bars that are hollow, or that may be solid, but that are not pre-tensioned. Thus, the prior art clamp bars tend to bow away from the conveyor belt when tightened to pull their ends together, and so they clamp relatively more tightly at the edges 52 of the conveyor belt 50 and relatively less tightly at and near the center of the conveyor belt. This produces a non-uniform or uneven distribution of force across the width of the conveyor belt as indicated by the arrows of differing length extending from the conveyor belt in the direction opposite to the direction it is pulled by pulling on the clamp.

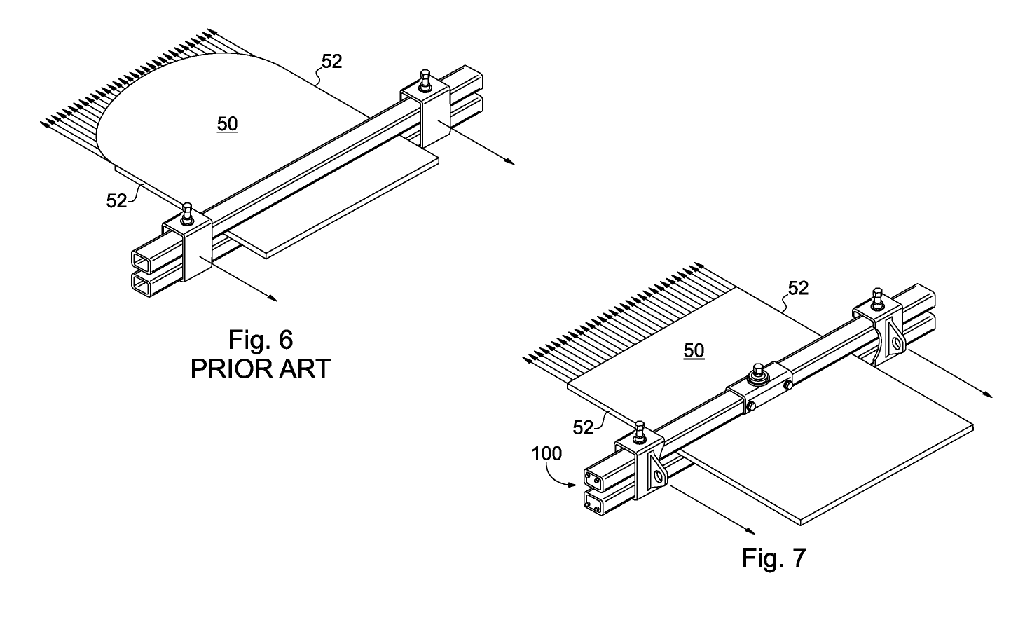

FIG. 7 is an isometric view of an example conveyor belt clamp 100 of FIG. 1 clamped to a conveyor belt 50 to illustrate the relatively more even distribution of pulling forces across the width of the conveyor belt 50 obtained thereby. The present belt clamp 100 employs one or both clamping bars 110 that are pre-stressed or pre-tensioned. Thus, the present clamp bars 110 tend to bow towards the conveyor belt 50 at its center and when tightened to pull their ends together, to continue to exert substantial clamping force at and near the center of the conveyor belt 50. This produces a relatively uniform or even distribution of force across the width of the conveyor belt as indicated by the arrows of similar length extending from the conveyor belt in the direction opposite to the direction it is pulled by pulling on the clamp bar 100.

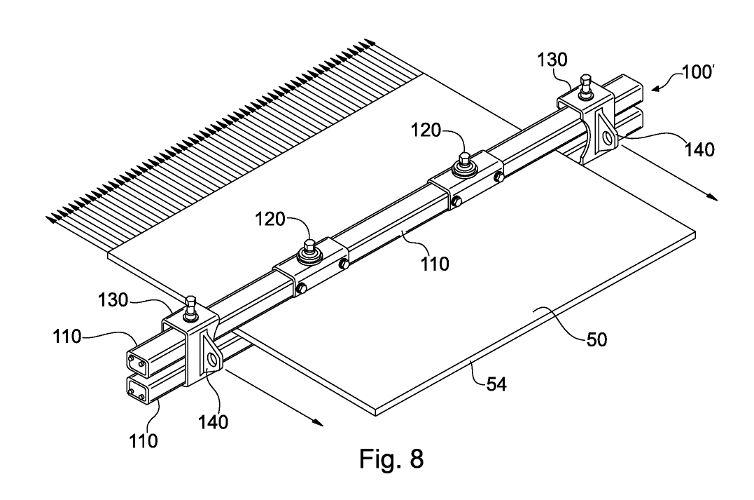

FIG. 8 is an isometric view of an example embodiment of a conveyor belt clamp 100′ having plural intermediate clamping devices 120 along its length and that is clamped to a cut end 54 of a conveyor belt for pulling the cut end of the belt. The upper bar 110 thereof has two center clamps 120 spaced along its length so as to be tightenable after the ends of the upper and lower clamp bars 110 are pulled together by the tightening of the end clamps 130. While this clamping arrangement including end clamps 130 and upper and lower clamp bars 110, at least one of which is pre-stressed or tensioned so as to bow toward the conveyor belt 50 near its center, does provide a more uniform distribution of pulling force across the width of the conveyor belt, in view of the greater width of the conveyor belt, two tightenable center clamps 120 are provided instead of only one near the center. The two center clamps 120 are preferably symmetrically offset to either side from the center of the clamping bar 110, e.g., at about the one-third and two-thirds positions along the length of the upper clamping bar 110.

In the conveyor belt clamp 100 described herein, one or both of the upper and lower clamp beams 110 are pre-stressed so that greater force is transferred to the center of the conveyor belt 50 when the upper and lower beams 110 are clamped together. It is noted that only one beam 110, preferably the top beam, has to be pre-stressed for the clamps to operate as desired. Preferably the upper and lower beams 110 are pre-stressed such that their ends are deflected away from the surface of the belt prior tightening of the end clamps 130. When the end clamps 130 are tightened, a region of the convex side 110c of the pre-stressed clamp beam 110 away from the ends thereof, e.g., generally near the center of the pre-stressed clamp beam if the end clamps 130 are tightened relatively evenly, and the centers of the pre-stressed beams 110 generally contact the belt first. Contact between the two beams 110 and the belt 50 progresses from the center of the belt 50 towards the edges of the belt as the end clamps 130 are progressively tightened. The conveyor belt clamp 100 may have one or more clamping mechanisms (clamping devices) 120 on the beams 110 thereof across the width of the conveyor belt 50. The conveyor belt clamp 100 preferably has a relatively consistent (uniform) clamping force across the width of the belt. The conveyor belt clamp 100 may have tension rods 116 installed in the upper beam 110, in the lower beam 110, or in both the upper and lower beams 110. A conveyor belt 50 is installed between the upper and lower beams 110, and the belt clamp 100 provides relatively even distribution of pulling force across the width of the belt 50.

In an example conveyor belt clamp suitable for use with a 30 inch (76.2 cm) wide conveyor belt, the two pre-stressed beams are aluminum and are about 34 inches (about 86.4 cm) long and about 2 inches by 3 inches (about 5.1 cm by 7.6 cm) in cross-section. The tensioning rods are ⅜ inch (about 0.95 cm) diameter steel rods with 16-NC threads for receiving 16-NC tensioning nuts at each end thereof. The end clamps are steel and are about 4 inches by 6 inches by 2 inches (about 10.2 cm by 15.2 cm by 5.1 cm) and the steel tightening bolts are 1-inch ACME thread bolts. Where the walls are of different thicknesses, the thin walls are about ¼ inch (about 0.64 cm) thick and the thicker wall is about ⅜ inch (about 0.95 cm) thick.

A conveyor belt clamp 100 may comprise: first and second clamp beams 110, 110′ for being placed against a conveyor belt 50, one or both of the first and second clamp beams 110 may be pre-stressed for deflecting a central region along the length of the clamp beam 110; a first end clamp 130 for being placed over a first end of each of the first and second clamp beams 110, respectively, and a second end clamp 130 for being placed over an other end of each of the first and second clamp beams 110, respectively, wherein each of the first and second end clamps 130 includes a tightening device 136 for forcing the ends of the first and second clamp beams 110 closer together; wherein the one or both of the first and second clamp beams 110 is for being placed with its convex side 110c against a surface of a conveyor belt 50 for clamping the conveyor belt 50. Both of the first and second clamp beams 110 may be pre-stressed so as to have respective convex sides 110c for being placed against a surface of a conveyor belt 50. The pre-stressed one 110 of the first and second clamp beams 110, 110′ may comprise: an elongated beam member 112 having a longitudinal neutral axis NA and first and second ends; and a tensioning member 116, 118 connected to the first and second ends of the elongated beam member 112 and offset from the longitudinal neutral axis NA thereof, for pre-stressing the elongated beam member 112. The elongated beam member 112 may be hollow and the tensioning member 116 may be disposed within the hollow elongated beam member. Where the elongated beam member 112 is hollow, one wall 110c of the elongated beam member may be thicker than other walls thereof, whereby the neutral axis NA of the elongated beam member 112 is offset from the centerline CL thereof. Tensioning member 116, 118 may include a tensioning rod 116 attached at the first and second ends of elongated beam member 112 and a tightening device 118 for increasing and decreasing tension of tensioning rod 116. The pre-stressed one 110 of the first and second clamp beams 110, 110′ may comprise: an elongated beam member 112 having first and second ends; and at least one center clamp 120 on the elongated beam member 110 at a location between the first and second ends thereof. The first and second end clamps 130 may each comprise: a frame 132 defining a central opening of sufficient size to receive respective ends of first and second clamp beams 110, 110′ therein; wherein tightening device 134, 136 may include a threaded member 136 threadingly engaging frame 132 for rotating in a first direction for advancing into the central opening of frame 132 for pressing against first and second clamp beams 110, 110′ therein and for rotating in an opposite direction for withdrawing out of the central opening. Threaded member 134, 136 may include a bolt 136 engaging a threaded opening 134 of frame 132, and frame 132 may further include a pulling lug 140 on an outer surface thereof. The pre-stressed one or both of the first and second clamp beams 110, 110′ may be placed against the conveyor belt 50 with the center thereof making contact with the conveyor belt 50 in a region away from its edges 52, and the first and second end clamps 130 may be tightened so that contact between the first and second clamp beams 110, 110′ and the conveyor belt 50 progresses from the region away from the edges 52 of the conveyor belt 50 towards the edges 52 thereof as the end clamps 130 are progressively tightened. The conveyor belt clamp 100 may further comprise one or more clamping mechanisms 120 located at one or more locations on the pre-stressed one 110 of the first and second clamp beams 110, 110′ across the width of the conveyor belt 50. The conveyor belt clamp 100 may be in combination with a conveyor belt 50, wherein the conveyor belt 50 is clamped between the first and second clamp beams 110, 110′ by the first and second end clamps 130.

A method for clamping a conveyor belt may comprise:
providing first and second clamp beams 110, 110′, one or both of which 110 is pre-stressed for having a convex side 110c;
placing the first and second clamp beams 110, 110′ transversely across the width of a conveyor belt 50 with the convex side 110c of the one or both clamp beams 110, 110c adjacent the conveyor belt 50;
placing a first end clamp 130 over first ends of the first and second clamp beams 110, 110′;
placing a second end clamp 130 over second ends of the first and second clamp beams 110, 110′; and
tightening the first and second end clamps 130 for forcing the ends of the first and second clamp beams 110, 110′ closer together for clamping the conveyor belt 50 therebetween.
   The method may further comprise: tightening a clamp device 120 located on one of the first and second clamp beams 110, 110′ for clamping the conveyor belt 50 in a region away from its edges 52. The method may further comprise: pulling on the conveyor belt 50 by pulling on respective pulling lugs 140 of the first and second end clamps 130. The method may further comprise: loosening the first and second end clamps 130 for releasing the clamping pressure of the first and second clamp beams 110, 110′ on the conveyor belt 50; and removing the first and second end clamps 130 from the first and second clamp beams 110, 110′ and the first and second clamp beams 100, 100′ from the conveyor belt 50.

A conveyor belt clamp 100 may comprise: first and second clamp beams 110, 110′, one or both of which 110 is pre-stressed for having a convex side 110c; wherein the first and second clamp beams 110, 110′ are placed transversely across the width of a conveyor belt 50 with the convex side 110c of the one or both clamp beams 110, 110′ adjacent the conveyor belt 50; a first end clamp 130 disposed over first ends of the first and second clamp beams 110, 110′ with the conveyor belt 50 therebetween; a second end clamp 130 disposed over second ends of the first and second clamp beams 110, 110′ with the conveyor belt 50 therebetween; and means 130 for tightening the first and second end clamps 110, 110′ for forcing the ends of the first and second clamp beams 110, 110′ closer together for clamping the conveyor belt 50 therebetween. The conveyor belt clamp 100 may further comprise means for tightening 120, 126 at least one additional clamp 120 for clamping a central region of the first clamp beam 110 against the conveyor belt 50.

A conveyor belt clamp 100 may comprise: first and second clamp beams 110, 110′ for being placed against opposing surfaces of a conveyor belt 50, at least one 110 of said first and second clamp beams 110, 100′ may comprise: an elongated beam member 112 having a longitudinal neutral axis NA and first and second ends; and a tensioning member 116,118 connected to the first and second ends of elongated beam member 110 and offset from the longitudinal neutral axis NA thereof for pre-stressing elongated beam member 110 and deflecting a central region 110c along the length thereof, whereby the at least one 110 of first and second clamp beams 110, 110′ is bent and has a convex side 110c; first and second end clamps 130 may each comprise a frame 132 and a tightening device 134, 136, the frame 132 of first end clamp 130 for being placed over a first end of each of the first and second clamp beams 110, 110′, respectively, the frame 132 of second end clamp 130 for being placed over an other end of each of the first and second clamp beams 110, 110′, respectively, wherein the tightening device 134, 136 of each of first and second end clamps 130 is tightenable for forcing the ends of the first and second clamp beams 110, 110′ closer together; wherein the at least one 110 of first and second clamp beams 110, 110′ is for being placed with its convex side 110c against a surface of a conveyor belt 50 for clamping the conveyor belt 50. The elongated beam member 112 may be hollow and tensioning member 116, 118 may be disposed within the hollow elongated beam member 112; or elongated beam member 112 may be hollow and one wall of elongated beam member 112 may be thicker than other walls thereof, whereby the neutral axis NA of elongated beam member 112 is offset from the centerline CL thereof; or elongated beam member 112 may be hollow and one wall of elongated beam member 112 may be thicker than other walls thereof, whereby the neutral axis NA of elongated beam member 110 may be offset from the centerline CL thereof and tensioning member 116 may be disposed within the hollow elongated beam member 112. The at least one 110 of first and second clamp beams 100, 100′ may comprise: at least one center clamp 120 on elongated beam member 112 at a location between the first and second ends thereof. First and second end clamps 130 may each comprise: a frame 132 defining a central opening of sufficient size to receive respective ends of first and second clamp beams 110, 110′ therein; and tightening device 134, 136 may include a threaded member 136 threadingly engaging frame 132 for rotating in a first direction for advancing into the central opening of frame 132 for pressing against first and second clamp beams 110, 110′ therein and for rotating in an opposite direction for withdrawing out of the central opening. Threaded member 136 may include a bolt 136 engaging a threaded opening 134 of frame 132, and frame 132 may further include a pulling lug 140 on an outer surface thereof.

A conveyor belt clamp 100 may comprise: first and second elongated clamp beams 110, 110′ for being placed against opposing surfaces of a conveyor belt 50, wherein each of first and second elongated clamp beams 110. 110′ comprises an elongated beam member 112 having first and second ends; at least one center clamp 120 on at least one of first and second elongated clamp beams 110, 110′ at a location between the first and second ends thereof; first and second end clamps 130 each comprising a frame 132 and a tightening device 134, 136, the frame 132 of first end clamp 130 for being placed over a first end of each of the first and second elongated clamp beams 110,110′, respectively, the frame 132 of second end clamp 130 for being placed over an other end of each of the first and second elongated clamp beams, 110,110′, respectively, wherein the tightening device 134, 136 of each of first and second end clamps 130 is tightenable for forcing the ends of the first and second elongated clamp beams 110, 110′ closer together; and wherein at least one center clamp 120 is tightenable for applying clamping force to the conveyor belt 50 at the location between the first and second ends of the at least one of said first and second elongated clamp beams 110, 110′. Center clamp 120 may comprise: a tightening device 122, 124, 126 including a threaded member 126 threadingly engaging the at least one of first and second elongated clamp beams 110, 110′ for rotating in a first direction for advancing towards the conveyor belt 50 for pressing against the conveyor belt 50 and for rotating in an opposite direction for withdrawing away from the conveyor belt 50. Threaded member 126 may include a bolt 126 engaging a threaded opening 122, 124 of the at least one of said first and second elongated clamp beams 110, 110′. Each elongated beam member 112 may have a longitudinal neutral axis NA and wherein at least one of the first and second elongated clamp beams 110, 110′ may comprise: a tensioning member 116, 118 connected to the first and second ends of the elongated beam member 112 thereof and offset from the longitudinal neutral axis NA thereof for pre-stressing elongated beam member 112 and deflecting a central region along the length thereof, whereby the at least one of first and second elongated clamp beams 110, 110′ is bent and has a convex side 110c, wherein the at least one of said first and second elongated clamp beams 110, 110′ is for being placed with its convex side 110c against a surface of the conveyor belt 50 for clamping the conveyor belt 50. The elongated beam member 112 may be hollow and tensioning member 116 may be disposed within the hollow elongated beam member 112; or elongated beam member 112 may be hollow and one wall of elongated beam member 112 may be thicker than other walls thereof, whereby the neutral axis NA of elongated beam member 112 is offset from the centerline CL thereof; or elongated beam member 112 may be hollow and one wall of elongated beam member 112 may be thicker than other walls thereof, whereby the neutral axis NA of elongated beam member 112 is offset from the centerline CL thereof and tensioning member 116 is disposed within the hollow elongated beam member 112. First and second end clamps 130 may each comprise: a frame 130 defining a central opening of sufficient size to receive respective ends of first and second elongated clamp beams 110, 110′ therein; wherein tightening device 134, 136 may include a threaded member 136 threadingly engaging frame 132 for rotating in a first direction for advancing into the central opening of frame 132 for pressing against first and second elongated clamp beams 110, 110′ therein and for rotating in an opposite direction for withdrawing out of the central opening. Threaded member 136 may include a bolt 136 engaging a threaded opening 134 of frame 132, and frame 132 may further include a pulling lug 140 on an outer surface thereof.

As used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

Although terms such as “up,” “down,” “left,” “right,” “front,” “rear,” “forward,” “backward,” “under” and/or “over,” may be used herein as a convenience in describing one or more embodiments and/or uses of the present arrangement, the articles described may be positioned in any desired orientation and/or may be utilized in any desired position and/or orientation. Such terms of position and/or orientation should be understood as being for convenience only, and not as limiting of the invention as claimed.

While the present invention has been described in terms of the foregoing example embodiments, variations within the scope and spirit of the present invention as defined by the claims following will be apparent to those skilled in the art. For example, either the upper beam 110 or the lower beam 110 or both may be pre-stressed or tensioned so as to exhibit a curved shape; however, each one of the beams 110 that is pre-stressed is intended to be placed with its convex side 110c facing the conveyor belt 50 so that clamping force is provided and maintained near the center of the belt 50. The first and second clamp beams 110, 110′ herein include two pre-stressed clamp beams 110 or one pre-stressed clamp beam 110 and one clamp beam 110, i.e. one or both clamp beams is a pre-stressed clamp beam 110.

While it is preferred that the tensioning device 116 employed to pre-stress a clamp beam 110 be located in the hollow interior of the beam 112, a tensioning device 116 may be located external to beam 112 because the tension produced will cause compression of the side of the beam on which the tensioning device 116 is located, thereby tending to bend the beam 112 in the direction such that the convex side 110c is opposite the tensioning device and is therefore exposed and available to be placed into contact with a conveyor belt 50.

While end clamps 130 and center clamps 120 may utilize a simple bolt-like mechanism 134-136, 122-126 for clamping down on the respective ends of clamp beams 110, 110′ as is shown, any mechanism that produces a suitable clamping force, e.g., as by threads or cams or cables or other means, may be employed. While a load spreading device such as pressure plates 128, 138 at the contact ends of bolts 126, 136 may be employed, the use of such plates is optional and the size thereof is typically adjusted for the expected loading and stress.

The optional center clamp 120 may be omitted where the width of the conveyor belt 50 is sufficiently narrow that the one or two pre-stressed clamp beams 100 of the present conveyor belt clamp arrangement 100 provides sufficient uniformity of pulling forces across the width of the conveyor belt 50. One or more center clamps 120 may be provided for use with relatively wider belts so that additional clamping force may be provided at one or more locations between the edges 52 of the conveyor belt 50.

Typically the center clamps 120 are symmetrically provided so as to provide for a relatively uniform distribution of the pulling forces, however, other non-symmetrical placements may be utilized. While the illustrated example center clamp 120 is affixed to a pre-stressed clamp beam 110, one or more center clamps 120 may be utilized with a pre-stressed clamp beam 110 and/or one or more center clamps 120 may be utilized with a non-pre-stressed clamp beam 110′ that opposes a pre-stressed clamp beam 110. The center clamp or clamps 120 may be fixed at a predetermined location on the clamp beam 110, 110′ or may be movable to a desired position thereon.

The terms “upper” and “lower” are used for convenience only and are not limiting as to how the present conveyor belt clamp may be employed or utilized. The “upper” beam may be placed under the conveyor belt and the “lower” beam may be placed over the conveyor belt. The tightening bolts of the end clamps may be in any position as may be convenient, and need not be against the “upper” beam, and the two end clamps do not need to be placed on the clamping beams in the same orientation, and similar variations may apply to the one or more center clamps.

Each of the U.S. Provisional Applications, U.S. patent applications, and/or U.S. patents identified herein are hereby incorporated herein by reference in their entirety.

Finally, numerical values stated are typical or example values, are not limiting values, and do not preclude substantially larger and/or substantially smaller values. Values in any given embodiment may be substantially larger and/or may be substantially smaller than the example or typical values stated.

What is claimed is:

1. A conveyor belt clamp comprising:
first and second clamp beams for being placed against opposing surfaces of a conveyor belt, one or both of said first and second clamp beams being pre-stressed for deflecting a central region along the length of the clamp beam, whereby the one or both clamp beams are bent and have a convex side;
first and second end clamps, said first end clamp for being placed over a first end of each of the first and second clamp beams, respectively, said second end clamp for being placed over an other end of each of the first and second clamp beams, respectively, wherein each of said first and second end clamps includes a tightening device for forcing the ends of the first and second clamp beams closer together;
wherein the one or both of said first and second clamp beams is for being placed with its convex side against a surface of a conveyor belt for clamping the conveyor belt.

2. The conveyor belt clamp of claim 1 wherein both of said first and second clamp beams are pre-stressed so as to have respective convex sides for being placed against a surface of a conveyor belt.

3. The conveyor belt clamp of claim 1 wherein the pre-stressed one of said first and second clamp beams comprises:
an elongated beam member having a longitudinal neutral axis and first and second ends; and
a tensioning member connected to the first and second ends of said elongated beam member and offset from the longitudinal neutral axis thereof, for pre-stressing said elongated beam member.

4. The conveyor belt clamp of claim 3 wherein said elongated beam member is hollow and wherein said tensioning member is disposed within the hollow elongated beam member.

5. The conveyor belt clamp of claim 3 wherein said elongated beam member is hollow and wherein one wall of said elongated beam member is thicker than other walls thereof, whereby the neutral axis of said elongated beam member is offset from the centerline thereof.

6. The conveyor belt clamp of claim 3 wherein said tensioning member includes a tensioning rod attached at the first and second ends of said elongated beam member and a tightening device for increasing and decreasing tension of said tensioning rod.

7. The conveyor belt clamp of claim 1 wherein the pre-stressed one of said first and second clamp beams comprises:
an elongated beam member having first and second ends; and
at least one center clamp on said elongated beam member at a location between the first and second ends thereof.

8. The conveyor belt clamp of claim 1 wherein said first and second end clamps each comprise: a frame defining a central opening of sufficient size to receive respective ends of said first and second clamp beams therein; wherein said tightening device includes a threaded member threadingly engaging said frame for rotating in a first direction for advancing into the central opening of said frame for pressing against said first and second clamp beams therein and for rotating in an opposite direction for withdrawing out of the central opening.

9. The conveyor belt clamp of claim 8 wherein said threaded member includes a bolt engaging a threaded opening of said frame, said frame further including a pulling lug on an outer surface thereof.

10. The conveyor belt clamp of claim 1 wherein the pre-stressed one or both of said first and second clamp beams is placed against the conveyor belt with the center thereof making contact with the conveyor belt in a region away from its edges, and wherein the first and second end clamps are tightened so that contact between the first and second clamp beams and the conveyor belt progresses from the region away from the edges of the conveyor belt towards the edges thereof as the end clamps are progressively tightened.

11. The conveyor belt clamp of claim 1 further comprising one or more clamping mechanisms located at one or more locations on the pre-stressed one of said first and second clamp beams across the width of the conveyor belt.

12. The conveyor belt clamp of claim 1 in combination with a conveyor belt, wherein the conveyor belt is clamped between said first and second clamp beams by said first and second end clamps.

13. A method for clamping a conveyor belt comprising:
providing first and second clamp beams, one or both of which is pre-stressed for having a convex side;
placing the first and second clamp beams transversely across the width of a conveyor belt with the conveyor belt therebetween and with the convex side of the one or both clamp beams adjacent the conveyor belt;
placing a first end clamp over first ends of the first and second clamp beams;
placing a second end clamp over second ends of the first and second clamp beams; and
tightening the first and second end clamps for forcing the ends of the first and second clamp beams closer together for clamping the conveyor belt therebetween.

14. The method of claim 13 further comprising:
tightening a clamp device located on one of the first and second clamp beams for clamping the conveyor belt in a region away from its edges.

15. The method of claim 13 further comprising:
pulling on the conveyor belt by pulling on respective pulling lugs of the first and second end clamps.

16. The method of claim 13 further comprising:
loosening the first and second end clamps for releasing the clamping pressure of the first and second clamp beams on the conveyor belt; and
removing the first and second end clamps from the first and second clamp beams and the first and second clamp beams from the conveyor belt.

17. A conveyor belt clamp comprising:
first and second clamp beams, one or both of which is pre-stressed for having a convex side;
wherein the first and second clamp beams are for being placed transversely across the width of a conveyor belt with the convex side of the one or both clamp beams adjacent the conveyor belt;
a first end clamp disposed over first ends of the first and second clamp beams with the conveyor belt therebetween;
a second end clamp disposed over second ends of the first and second clamp beams with the conveyor belt therebetween; and
means for tightening the first and second end clamps for forcing the ends of the first and second clamp beams closer together for clamping the conveyor belt therebetween.

18. The conveyor belt clamp of claim 17 further comprising: means for clamping a central region of the first clamp beam against the conveyor belt.

19. A conveyor belt clamp comprising:
first and second clamp beams for being placed against opposing surfaces of a conveyor belt, at least one of said first and second clamp beams comprising:
an elongated beam member having a longitudinal neutral axis and first and second ends; and
a tensioning member connected to the first and second ends of said elongated beam member and offset from the longitudinal neutral axis thereof for pre-stressing said elongated beam member and deflecting a central region along the length thereof, whereby the at least one of said first and second clamp beams is bent and has a convex side;
first and second end clamps each comprising a frame and a tightening device, the frame of said first end clamp for being placed over a first end of each of the first and second clamp beams, respectively, the frame of said second end clamp for being placed over an other end of each of the first and second clamp beams, respectively, wherein the tightening device of each of said first and second end clamps is tightenable for forcing the ends of the first and second clamp beams closer together;
wherein the at least one of said first and second clamp beams is for being placed with its convex side against a surface of a conveyor belt for clamping the conveyor belt.

20. The conveyor belt clamp of claim 19 wherein:
said elongated beam member is hollow and wherein said tensioning member is disposed within the hollow elongated beam member; or
said elongated beam member is hollow and wherein one wall of said elongated beam member is thicker than other walls thereof, whereby the neutral axis of said elongated beam member is offset from the centerline thereof; or
said elongated beam member is hollow and wherein one wall of said elongated beam member is thicker than other walls thereof, whereby the neutral axis of said elongated beam member is offset from the centerline thereof and wherein said tensioning member is disposed within the hollow elongated beam member.

21. The conveyor belt clamp of claim 19 wherein the at least one of said first and second clamp beams comprises: at least one center clamp on said elongated beam member at a location between the first and second ends thereof.

22. The conveyor belt clamp of claim 19 wherein said first and second end clamps each comprise: a frame defining a central opening of sufficient size to receive respective ends of said first and second clamp beams therein; wherein said tightening device includes a threaded member threadingly engaging said frame for rotating in a first direction for advancing into the central opening of said frame for pressing against said first and second clamp beams therein and for rotating in an opposite direction for withdrawing out of the central opening.

23. The conveyor belt clamp of claim 22 wherein said threaded member includes a bolt engaging a threaded opening of said frame, said frame further including a pulling lug on an outer surface thereof.

24. A conveyor belt clamp comprising:
first and second elongated clamp beams for being placed against opposing surfaces of a conveyor belt,
wherein each of said first and second elongated clamp beams comprises an elongated beam member having first and second ends;
at least one center clamp on at least one of said first and second elongated clamp beams at a location between the first and second ends thereof;
first and second end clamps each comprising a frame and a tightening device, the frame of said first end clamp for being placed over a first end of each of the first and second elongated clamp beams, respectively, the frame of said second end clamp for being placed over an other end of each of the first and second elongated clamp beams, respectively, wherein the tightening device of each of said first and second end clamps is tightenable for forcing the ends of the first and second elongated clamp beams closer together; and
wherein said at least one center clamp is tightenable for applying clamping force to the conveyor belt at the location between the first and second ends of said at least one of said first and second elongated clamp beams.

25. The conveyor belt clamp of claim 24 wherein said at least one center clamp comprises:
a tightening device including a threaded member threadingly engaging said at least one of said first and second elongated clamp beams for rotating in a first direction for advancing towards the conveyor belt for pressing against the conveyor belt and for rotating in an opposite direction for withdrawing away from the conveyor belt.

26. The conveyor belt clamp of claim 25 wherein said threaded member includes a bolt engaging a threaded opening of said at least one of said first and second elongated clamp beams.

27. The conveyor belt clamp of claim 24 wherein each elongated beam member has a longitudinal neutral axis and wherein at least one of said first and second elongated clamp beams comprises:
a tensioning member connected to the first and second ends of said elongated beam member thereof and offset from the longitudinal neutral axis thereof for pre-stressing said elongated beam member and deflecting a central region along the length thereof, whereby the at least one of said first and second elongated clamp beams is bent and has a convex side,
wherein the at least one of said first and second elongated clamp beams is for being placed with its convex side against a surface of the conveyor belt for clamping the conveyor belt.

28. The conveyor belt clamp of claim 27 wherein:
said elongated beam member is hollow and wherein said tensioning member is disposed within the hollow elongated beam member; or
said elongated beam member is hollow and wherein one wall of said elongated beam member is thicker than other walls thereof, whereby the neutral axis of said elongated beam member is offset from the centerline thereof; or
said elongated beam member is hollow and wherein one wall of said elongated beam member is thicker than other walls thereof, whereby the neutral axis of said elongated beam member is offset from the centerline thereof and wherein said tensioning member is disposed within the hollow elongated beam member.

29. The conveyor belt clamp of claim 24 wherein said first and second end clamps each comprise: a frame defining a central opening of sufficient size to receive respective ends of said first and second elongated clamp beams therein; wherein said tightening device includes a threaded member threadingly engaging said frame for rotating in a first direction for advancing into the central opening of said frame for pressing against said first and second elongated clamp beams therein and for rotating in an opposite direction for withdrawing out of the central opening.

30. The conveyor belt clamp of claim 29 wherein said threaded member includes a bolt engaging a threaded opening of said frame, said frame further including a pulling lug on an outer surface thereof.
